(19) United States
(12) Patent Application Publication
(10) Pub. No.: US 2015/0286013 A1
(43) Pub. Date: Oct. 8, 2015

(54) OPTICAL CONNECTOR APPARATUS

(71) Applicant: Yazaki Corporation, Tokyo (JP)

(72) Inventor: Kaoru MATSUMURA, Susono-shi (JP)

(73) Assignee: Yazaki Corporation, Tokyo (JP)

(21) Appl. No.: 14/743,156

(22) Filed: Jun. 18, 2015

Related U.S. Application Data
(63) Continuation of application No. PCT/JP2013/084485, filed on Dec. 24, 2013.

(30) Foreign Application Priority Data
Dec. 26, 2012 (JP) 2012-282489

(51) Int. Cl. G02B 6/38

(52) U.S. Cl. CPC G02B 6/3893; G02B 6/3825; G02B 6/387; G02B 6/3887

(57) ABSTRACT

In the present invention, a plug-side ferrule is urged toward a fitting direction of a plug-side housing by a spring member provided in the plug-side housing. An in-line-side ferrule is positioned in a separating direction of an in-line-side housing by a positioning fixing part provided in the in-line-side housing.

### CROSS REFERENCE TO RELATED APPLICATIONS

This application is a Continuation of PCT Application No. PCT/JP2013/084485 filed on Dec. 24, 2013, and claims the priority of Japanese Patent Application No. 2012-282489 filed on Dec. 26, 2012, the content of both of which is incorporated herein by reference.

### TECHNICAL FIELD

The present invention relates to an optical connector apparatus used for connection of optical fibers.

### BACKGROUND ART

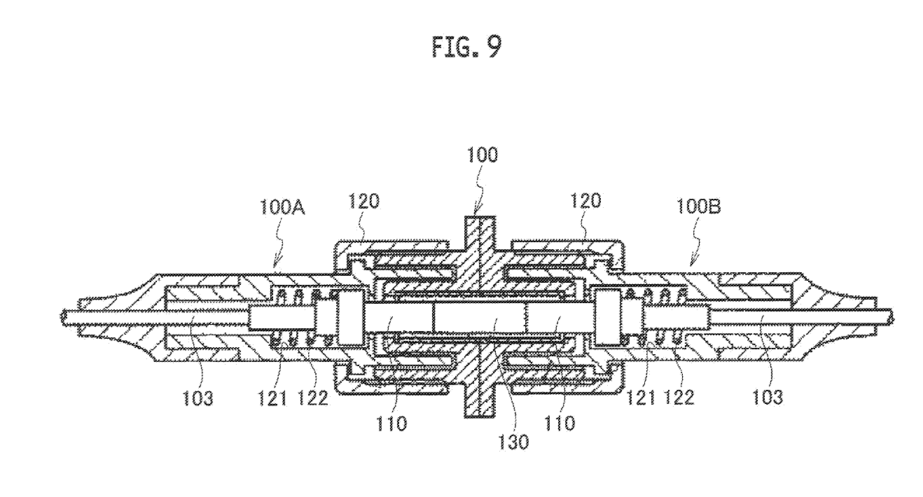

In regard to the optical connector apparatus used for connection of the optical fibers that perform optical transmission, such a proposal as indicated in, for example, Patent Literature 1 is made. One example of this kind of the optical connector apparatus will be described while referring to FIG. 9.

As shown in FIG. 9, an optical connector apparatus 100 is configured by mutually fitting optical connectors 100A, 100B. Each of the connectors 100A, 100B includes a ferrule 110 provided on a leading end of an optical fiber 103, and a housing 120 having a housing chamber 121 for housing the ferrule 110.

The respective ferrules 110 are connected together via a refractive index distribution type lens 130 that is lager in diameter than the optical fiber 103. Each ferrule 110 is urged toward the mating ferrule 110 by a coil spring 122 provided in the housing chamber 121 of the housing 120. This facilitates stabilization of connection between the respective optical fibers 103.

### CITATION LIST

### Patent Literature

Patent Literature 1: Japanese Patent Laid-Open Publication No. 2005-300594

### SUMMARY OF INVENTION

### Technical Problem

However, in the above-mentioned conventional optical connector apparatus 100, since the coil spring 122 is provided in each housing 120, there were such a problem that troubles (for example, high-cost and weight increase) caused by an increase in the number of components are induced and such a problem that the size of the housing 120 cannot be reduced. Although, for example, it is also conceivable not to provide the coil spring 122 in one of the housings 120, since positioning of the ferrule 110 on the side where this coil spring 122 is not provided is not stabilized, it is assumed that connection of mutual leading ends of the optical fibers 103 may become unstable.

Therefore, the present invention has been made in order to solve the above-mentioned problems, and aims to provide an optical connector apparatus capable of stabilizing connection of the optical fibers without inducing the troubles caused by an increase in the number of components.

### Solution to Problem

In order to solve the above-mentioned problems, the present invention has features as follows. That is, the optical connector apparatus of the present invention includes: a first optical connector having a first housing that retains a first ferrule provided on a leading end of a first optical fiber; and a second optical connector having a second housing that retains a second ferrule provided on a leading end of a second optical fiber, leading ends of the first ferrule and the second ferrule coming into contact with each other by fitting of the first housing to the second housing, wherein the first ferrule is urged toward a fitting direction of the first housing by an elastic body provided in the first housing, and the second ferrule is positioned in a separating direction of the second housing by a fixing part provided in the second housing.

The optical connector apparatus of the present invention may be characterized in that the second housing includes a second main body member and a second stopper member to be mounted to the second main body member, and the second ferrule is guided to the fixing part by a tapered part provided in the second stopper member in a process of mounting the second stopper member to the second main body member.

The optical connector apparatus of the present invention may be characterized in that the first housing includes a first main body member and a first stopper member to be mounted to the first main body member, and the elastic body is formed by a leaf spring one end of which is fixed to the first stopper member and the other end of which urges the first ferrule toward the fitting direction of the first housing.

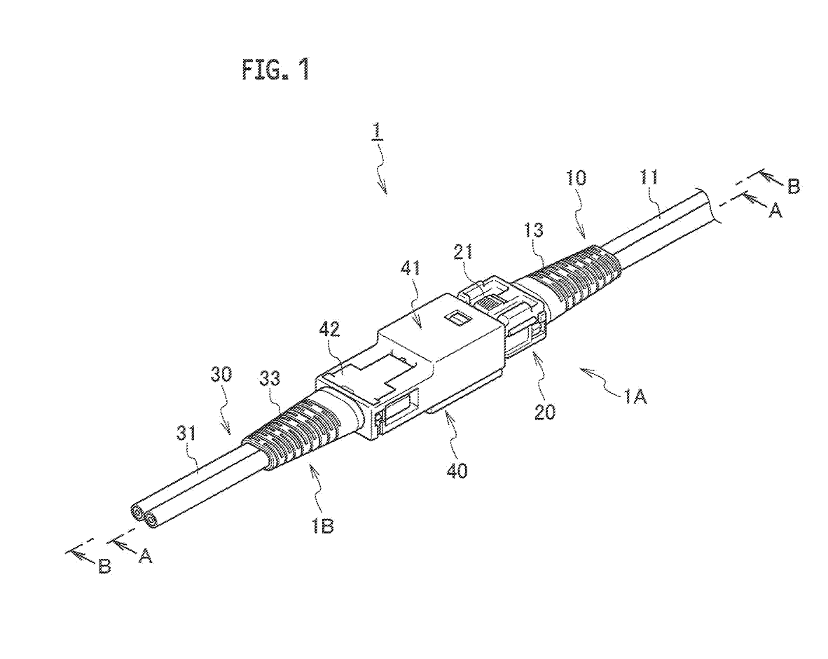

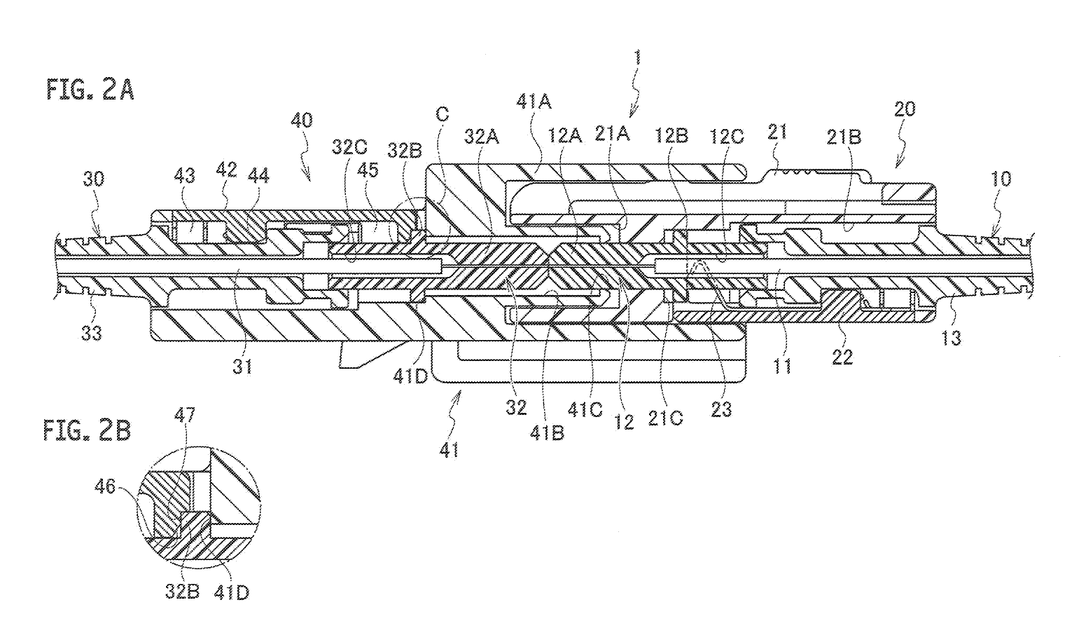

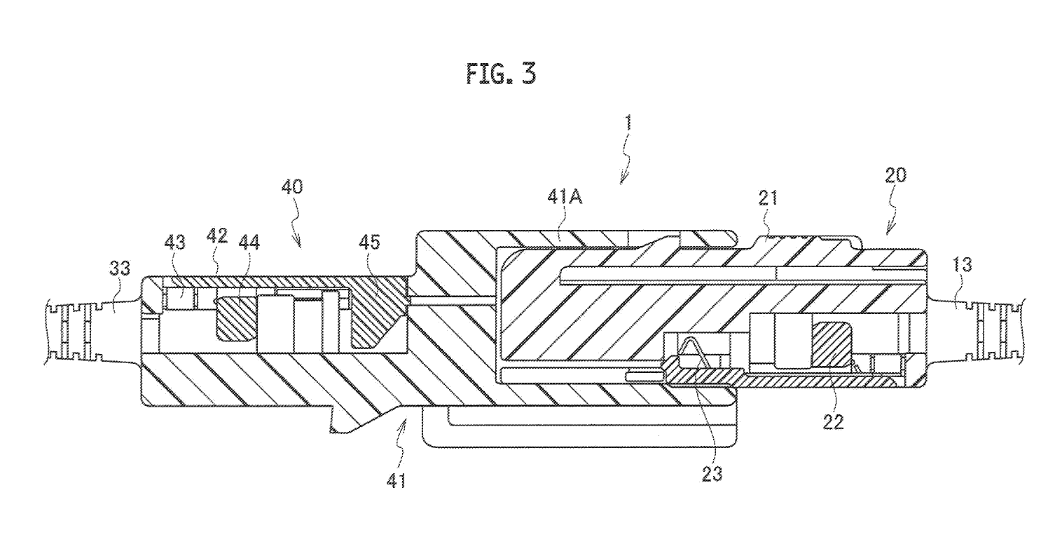

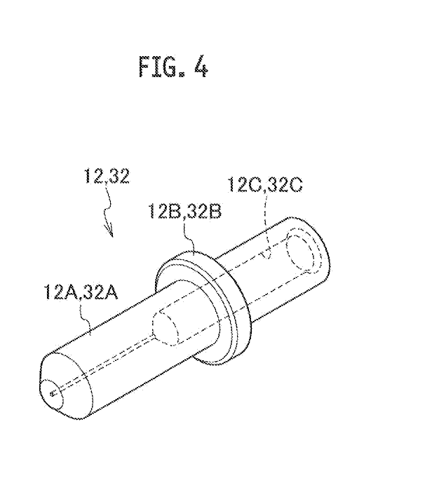

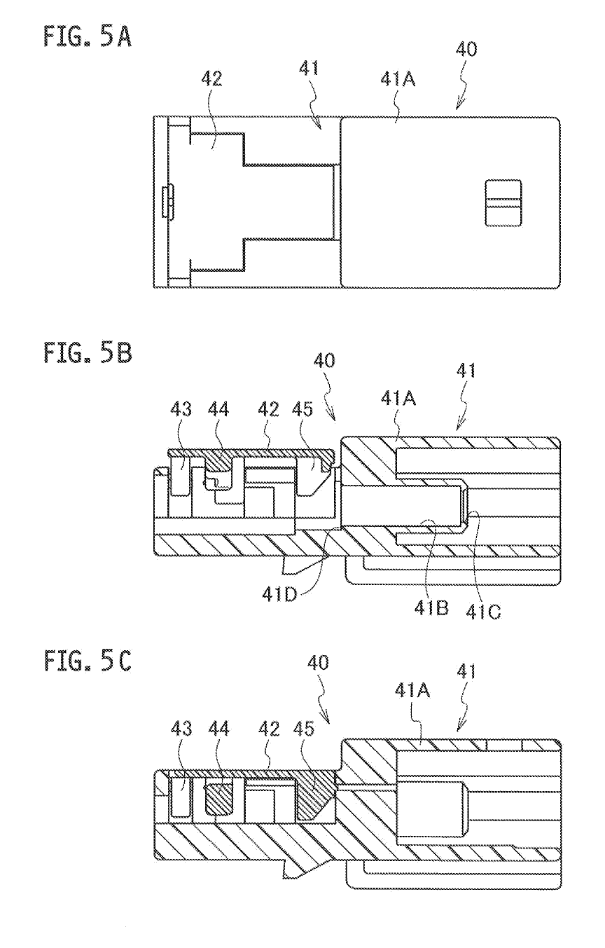

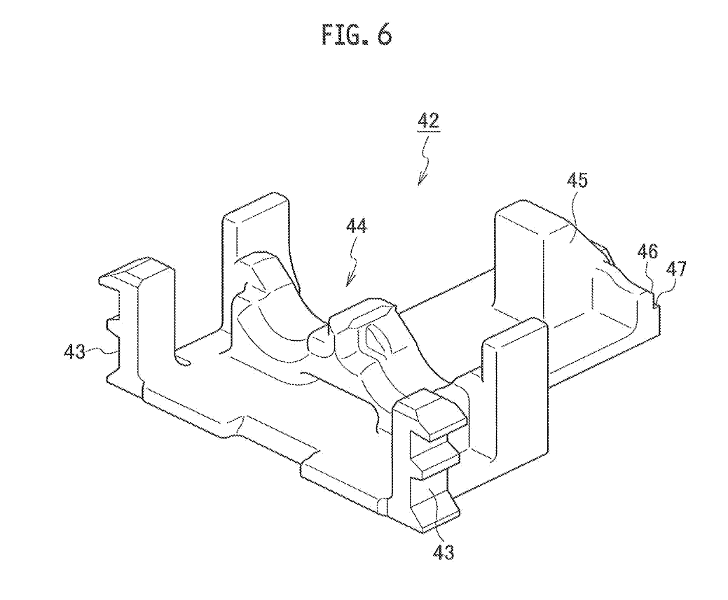

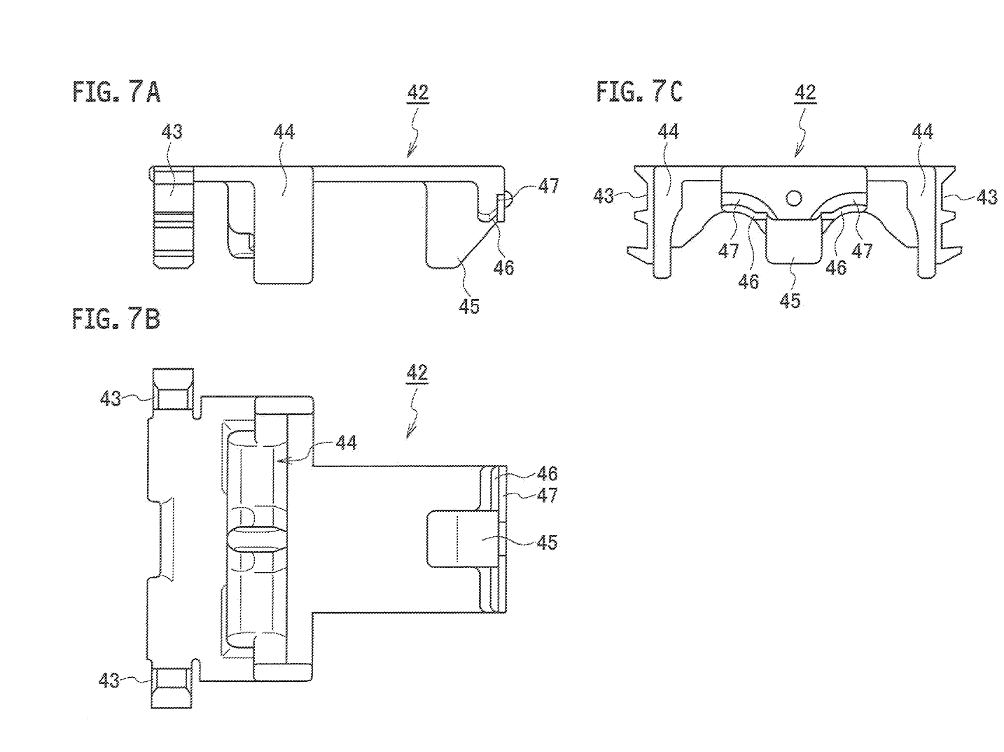

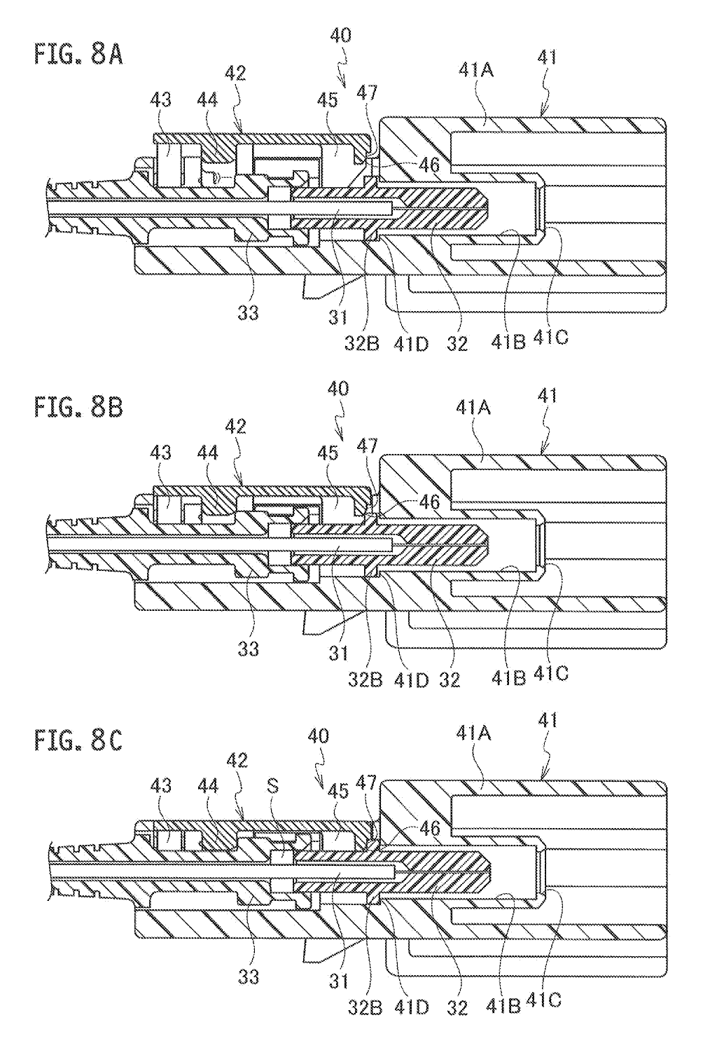

### BRIEF DESCRIPTION OF DRAWINGS

[FIG. 1] FIG. 1 is a perspective view showing an optical connector apparatus according to the present embodiment.

[FIG. 2A] FIG. 2A is a sectional diagram along A-A of FIG. 1.

[FIG. 2B] FIG. 2B is a C-part enlarged diagram of FIG. 2A.

[FIG. 3] FIG. 3 is a sectional diagram along B-B of FIG. 1.

[FIG. 4] FIG. 4 is a perspective view showing a ferrule according to the present embodiment.

[FIG. 5A] FIG. 5A is a plan view showing an in-line-side housing according to the present embodiment.

[FIG. 5B] FIG. 5B is a sectional diagram corresponding to FIG. 2A, showing an in-line-side housing according to the present embodiment.

[FIG. 5C] FIG. 5C is a sectional diagram corresponding to FIG. 3, showing an in-line-side housing according to the present embodiment.

[FIG. 6] FIG. 6 is a perspective view showing an in-line-side stopper according to the present embodiment.

[FIG. 7A] FIG. 7A is a side view showing an in-line-side stopper according to the present embodiment.

[FIG. 7B] FIG. 7B is a plan view showing an in-line-side stopper according to the present embodiment.

[FIG. 7C] FIG. 7C is a front view showing an in-line-side stopper according to the present embodiment.

[FIG. 8A] FIG. 8A is a diagram showing initial situation in an assembling process of the optical connector apparatus according to the present embodiment.

[FIG. 8B] FIG. 8B is a diagram showing a situation after the initial situation of FIG. 8A in an assembling process of the optical connector apparatus according to the present embodiment.

[FIG. 8C] FIG. 8C is a diagram showing a situation after the situation of FIG. 8B in an assembling process of the optical connector apparatus according to the present embodiment.

[FIG. 9] FIG. 9 is a sectional diagram showing an optical connector apparatus according to the background art.

### DESCRIPTION OF EMBODIMENTS

Next, embodiments of the optical connector apparatus according to the present invention will be described while referring to the drawings. Incidentally, in the following description of the drawings, the same or similar numerals are assigned to the same or similar parts. However, it is to be noted that the drawings are schematic and a ratio among respective dimensions and so forth are different from the actual ones. Accordingly, specific dimensions and so forth should be judged by taking the following description into consideration. In addition, also among the drawings, parts where mutual dimensional relations and ratios are made different may be included.

(Configuration of Optical Connector Apparatus)

First, a configuration of an optical connector apparatus 1 according to the present embodiment will be described while referring to the drawings. FIG. 1 is a perspective view showing the optical connector apparatus according to the present embodiment. FIG. 2A is a sectional diagram along A-A (a sectional diagram on a plane passing through the central axis of an optical fiber) of FIG. 1. FIG. 2B is a C-part enlarged diagram of FIG. 2A. FIG. 3 is a sectional diagram along B-B (a sectional diagram on a plane not passing through the central axis of the optical fiber and in the present embodiment, a sectional diagram on a plane of symmetry of the optical connector apparatus) of FIG. 1. FIG. 4 is a perspective view showing a ferrule according to the present embodiment. FIG. 5A, FIG. 5B and FIG. 5C show an in-line-side housing according to the present embodiment, wherein FIG. 5A is a plan view, FIG. 5B is a sectional diagram corresponding to FIG. 2A, and FIG. 5C is a sectional diagram corresponding to FIG. 3. FIG. 6 is a perspective view showing an in-line-side stopper according to the present embodiment. FIG. 7A, FIG. 7B and FIG. 7C show an in-line-side stopper according to the present embodiment, wherein FIG. 7A is a side view, FIG. 7B is a plan view, and FIG. 7C is a front view.

As shown in FIG. 1 to FIG. 3, the optical connector apparatus 1 includes a plug connector 1A as a first optical connector and an in-line connector 1B as a second optical connector.

(Plug Connector)

The plug connector 1A includes an optical fiber assembly 10, and a plug-side housing 20 as a first housing that retains the optical fiber assembly 10.

The optical fiber assembly 10 is configured by a plug-side optical fiber 11 as a first optical fiber that performs optical transmission, a plug-side ferrule 12 as a first ferrule provided on a leading end of the plug-side optical fiber 11, and a plug-side boot 13 that covers the plug-side optical fiber 11 to restrict bending.

The plug-side ferrule 12 has a tubular ferrule main body 12A, and a rib part 12B that projects outward from the ferrule main body 12A as shown in FIG. 4. A leading end insertion hole 12C into which the leading end of the plug-side optical fiber 11 is to be inserted is provided in the ferrule main body 12A.

The plug-side housing 20 includes a plug-side main body 21 as a box-shaped first main body member, and a plug-side stopper 22 as a first stopper member to be mounted to the plug-side main body 21 as shown in FIG. 1 to FIG. 3.

The plug-side main body 21 is provided with a fitting chamber 21A into which a mating in-line connector 1B is to be fitted, a housing chamber 21 B which communicates with the fitting chamber 21A and in which the plug-side ferrule 12 is to be housed, and a wall face 21 C with which the rib part 12B of the plug-side ferrule 12 can come into contact between the fitting chamber 21A and the housing chamber 21B.

A leading end of the plug-side ferrule 12 (i.e. the leading end located ahead of the rib part 12B, that is, a part located on the side closer to the mating ferrule relative to the rib part 12B) projects into the fitting chamber 21A, and this leading end of the plug-side ferrule 12 is provided to be movable in fitting and separating directions of the plug-side housing 20.

A back end (a back end that includes the rib part 12B, that is, a part located on the side far from the mating ferrule relative to the rib part 12B) of the plug-side ferrule 12 and a part of the plug-side boot 13 are provided in the housing chamber 21B. The plug-side stopper 22 is mounted to a lower surface of this housing chamber 21B.

The plug-side stopper 22 is provided with a spring member 23 as an elastic body that urges the rib part 12B of the plug-side ferrule 12 toward the fitting direction of the plug connector 1A as shown in FIG. 2A. The spring member 23 is fixed to the plug-side stopper 22 at its one end and the other end thereof is formed by a leaf spring that urges the plug-side ferrule 12 toward the fitting direction of the plug connector 1A.

(In-Line Connector)

The in-line connector 1B includes an optical fiber assembly 30, and an in-line-side housing 40 as a second housing that retains the optical fiber assembly 30.

The optical fiber assembly 30 is configured by an in-line-side optical fiber 31 as a second optical fiber that performs optical transmission, an in-line-side ferrule 32 as a second ferrule provided on a leading end of the in-line-side optical fiber 31, and an in-line-side boot 33 that covers the in-line-side optical fiber 31 to restrict bending.

The in-line-side ferrule 32 has a tubular ferrule main body 32A, and a rib part 32B that projects outward from the ferrule main body 32A as shown in FIG. 4. A leading-end insertion hole 32C into which the leading end of the in-line-side optical fiber 31 is to be inserted is provided in the ferrule main body 32A.

The in-line-side housing 40 includes an in-line-side main body 41 as a box-shaped second main body member, and an in-line-side stopper 42 as a second stopper member to be mounted to the in-line-side main body 41 as shown in FIG. 1 to FIG. 3, FIG. 5A, FIG. 5B and FIG. 5C.

The in-line-side main body 41 is provided with a fitting hood part 41A that covers the fitting chamber 21A of the mating plug connector 1A, and a housing chamber 41B in which the plug-side ferrule 12 is to be housed.

A part of the housing chamber 41B projects into the fitting hood part 41A. An insertion hole 41C into which the plug-side ferrule 12 is to be inserted within the fitting hood part 41A in fitting of the plug-side housing 20 to the in-line-side housing 40, and a rib abutment part 41D that can abut only on the front face side of the rib part 32B of the in-line-side ferrule 32 are formed in the housing chamber 41B.

Parts of the in-line-side ferrule 32 and in-line-side boot 33 are provided in the housing chamber 41B. The in-line-side stopper 42 is mounted onto an upper surface of this housing chamber 41B.

The in-line-side stopper 42 includes a locking claw part 43 to be locked to an engagement part (not shown) of the in-line-side main body 41, a boot support part 44 that supports the in-line-side boot 33, and a ferrule support part 45 that supports the in-line-side ferrule 32 as shown in FIG. 6, FIG. 7A, FIG. 7B and FIG. 7C.

The ferrule support part 45 is provided with a tapered part 46 that abuts on the in-line-side ferrule 32 in a process of mounting the in-line-side stopper 42 to the in-line-side main body 41, and a positioning fixing part 47 that positions the in-line-side ferrule 32 in the separating direction of the in-line-side housing 40.

The tapered part 46 comes into contact with the rib part 32B of the in-line-side ferrule 32 and guides the rib part 32B of the in-line-side ferrule 32 to the positioning fixing part 47. The positioning fixing part 47 is made to be in contact with only the rear face side of the rib part 32B and positions and fixes the rib part 32B of the in-line-side ferrule 32 that has been guided by the tapered part 46, together with the above-mentioned rib abutment part 41D.

(Assembling Process of Optical Connector Apparatus)

Next, an assembling process of the above-mentioned optical connector apparatus 1 will be briefly described while referring to the drawings. FIG. 8A, FIG. 8B and FIG. 8C are diagrams showing the assembling process of the optical connector apparatus 1 according to the present embodiment.

Here, the plug connector 1A and the in-line connector 1B are individually assembled separately. Incidentally, in the following, it is assumed that the plug connector 1A has already been assembled in order to describe the assembling process of the in-line connector 1B.

FIG. 8A, FIG. 8B and FIG. 8C show the process of mounting the in-line-side stopper 42 to the in-line-side main body 41. The in-line-side stopper 42 is gradually mounted to the in-line-side main body 41 in order in this drawing, and the in-line-side stopper 42 and the optical fiber assembly 30 come closer to each other. Here, the in-line-side stopper 42 is mounted to the in-line-side main body 41 in a state that the optical fiber assembly 30 has been housed in the housing chamber 41B of the in-line-side main body 41. FIG. 8C shows a situation that the in-line-side stopper 42 has been completely mounted to the in-line-side main body 41.

As shown in FIG. 8A and FIG. 8B, the in-line-side stopper 42 is gradually mounted to the in-line-side main body 41 with the optical fiber assembly 30 housed in the housing chamber 41 B. Then, as shown in FIG. 8B, the tapered part 46 of the in-line-side stopper 42 comes into abutment with the rib part 32B of the in-line-side ferrule 32 and guides the in-line-side ferrule 32 to the positioning fixing part 47. Thereby, the in-line-side ferrule 32 moves toward the fitting direction of the in-line-side housing 40.

Then, as shown in FIG. 8C, when the in-line-side stopper 42 is completely mounted to the in-line-side main body 41, the rib part 32B of the in-line-side ferrule 32 that has been guided by the tapered part 46 is nipped and held between the rib abutment part 41D and the positioning fixing part 47. Thereby, the in-line-side ferrule 32 is positioned and fixed in the separating direction of the in-line-side housing 40.

Thereafter, the plug connector 1A that has been assembled in advance is fitted to the assembled in-line connector 1B. Then, the plug-side ferrule 12 that is being urged by the spring member 23 comes into contact with the leading end of the in-line-side ferrule 32 that has been positioned by the positioning fixing part 47 and moves in the separating direction of the plug-side housing 20. That is, the rib part 12B moves so as to be separated from the wall face 21 C. Then, since the plug-side ferrule 12 is being urged toward the fitting direction by the spring member 23, relative to the in-line-side ferrule 32 that has been positioned by the positioning fixing part 47, the leading ends of the plug-side ferrule 12 and the in-line-side ferrule 32 come into contact with each other.

(Operation—Advantageous Effect)

In the above-described embodiment, when the plug-side housing 20 and the in-line-side housing 40 are fitted to each other, the plug-side ferrule 12 is urged toward the fitting direction by the spring member 23, relative to the in-line-side ferrule 32 that has been positioned by the positioning fixing part 47. Therefore, the leading ends of the plug-side ferrule 12 and the in-line-side ferrule 32 reliably come into contact with each other simply by providing the spring member 23 in the plug-side housing 20 without providing the spring member in the in-line-side housing 40. Owing to the above, it becomes possible to stabilize connection between the plug-side optical fiber 11 and the in-line-side optical fiber 31 and the optical loss can be suppressed without inducing the troubles (for example, high-cost and weight increase) caused by the increase in the number of components.

Incidentally, in a case where the coil springs are provided in the both housings as conventionally, it is feared that contact between the ferrules may become unstable (for example, a contact failure in association with weak expansion/contraction force of one of the coil springs) depending on the quality of each coil spring. In addition, it was necessary to provide expansion/contraction absorbing structures for absorbing expansion/contraction of the optical fiber with movement of each ferrule, in the both optical connectors.

For example, in a case where the coil springs are provided in the both housings, the contact position of the ferrules is shifted to the side where the expansion/contraction force of the coil spring is weak due to a difference in expansion/contraction force between the coil springs and connection of the optical fibers cannot be stabilized. In order to fix the contact position of the ferrules in a case where the coil springs are provided in the both housings, it is necessary to manage the quality of the coil springs with high accuracy, which leads to high-cost.

However, in the above-mentioned embodiment, quality management of only the spring member 23 provided in the plug-side housing 20 is needed owing to not providing the spring member in the in-line-side housing 40. In addition, there is no need to provide the expansion/contraction absorbing structure (not shown) in the in-line connector 1B, which contributes to a cost reduction and so forth.

Moreover, the in-line-side ferrule 32 that has been positioned by the positioning fixing part 47 will be always arranged at the same position in the in-line-side housing 40, and therefore the leading ends of the plug-side ferrule 12 and the in-line-side ferrule 32 can come into contact with each other always at a uniform position.

In the present embodiment, the in-line-side ferrule 32 can be smoothly moved and mounting of the in-line-side stopper 42 to the in-line-side main body 41 can be also smoothly performed by guiding the in-line-side ferrule 32 to the positioning fixing part 47 by the tapered part 46 in the process of mounting the in-line-side stopper 42 to the in-line-side main body 41, and assembling workability of the optical connector apparatus 1 is improved.

Moreover, whether the rib part 32B of the in-line-side ferrule 32 has been positioned by the positioning fixing part 47 can be detected depending on whether the in-line-side stopper 42 has been completely mounted to the in-line-side main body 41. That is, in a case where the in-line-side stopper 42 is not completely mounted to the in-line-side main body 41, it can be detected that the rib part 32B of the in-line-side ferrule 32 is not positioned by the positioning fixing part 47. On the other hand, in a case where the in-line-side stopper 42 has been completely mounted to the in-line-side main body 41, it can be detected that the rib part 32B of the in-line-side ferrule 32 has been positioned by the positioning fixing part 47.

In the present embodiment, a low-cost spring can be used because the spring member 23 is formed of a leaf spring, in comparison with a case where the spring member 23 is formed of a coil spring. As a result, high-cost can be suppressed. Moreover, the spring member 23 can be installed simply by mounting the plug-side stopper 22 to the plug-side main body 21 owing to provision of the spring member 23 on the plug-side stopper 22. In addition, the sizes of the plug-side housing 20 and the in-line-side housing 40 can be reduced in comparison with a case where the coil springs are attached around the plug-side optical fiber 11 and the in-line-side optical fiber 31. Therefore, it also contributes to a reduction in installation space.

### Other Embodiments

Although the content of the present invention has been disclosed through the embodiment of the present invention as mentioned above, it should not be understood that statement and the drawings that constitute parts of this disclosure limit the present invention. Various alternative embodiments, practical examples and application technologies will be revealed to a person skilled in the art from this disclosure.

For example, the embodiment of the present invention can be altered as follows. Specifically, it goes without saying that with respect to respective configurations, shapes and so forth of the optical connector apparatus 1, they are not limited to those described in the embodiment.

In addition, although description has been made on the assumption that one plug connector 1A is provided with the spring member 23 and the other in-line connector 1B is provided with the positioning fixing part 47, they are not limited to this and may have an inverse relation. That is, one plug connector 1A may be provided with the positioning fixing part and the other in-line connector 1B may be provided with the spring member.

In addition, although description has been made on the assumption that the spring member 23 is formed of the leaf spring, it is not limited to this, and it may be, for example, a coil spring that can urge the plug-side ferrule 12.

In addition, although description has been made on the assumption that the spring member 23 is fixed to the plug-side stopper 22 at its one end, it may just have the property as an elastic body in order to urge the plug-side ferrule 12 and is not limited to the spring member. For example, it may be the elastic body formed integrally with the plug-side stopper 22.

In addition, although description has been made on the assumption that the ferrule support part 45 is provided with the tapered part 46 and the positioning fixing part 47, it is not limited to this and, for example, it may be the one provided with only the positioning fixing part 47.

In addition, although description has been made on the assumption that the tapered part 46 and the positioning fixing part 47 are provided on the in-line-side stopper 42, they are not limited to this and may be provided on the in-line-side main body 41.

In addition, although description has been made on the assumption that the tapered part 46 and the positioning fixing part 47 come into contact with the rib part 32B of the in-line-side ferrule 32, they are not limited to this and they may come into contact with a projected part (a projection for exclusive use and so forth) that has been provided in addition to the rib part 32B.

Although the embodiments of the present invention have been described hereinabove, these embodiments are mere illustrations that have been described for easy understanding of the present invention. The present invention includes various embodiments and so forth that are not described here and is not limited to the embodiments concerned. The technical scope of the present invention is defined only by the invention-specifying matters according to the pertinent scope of patent claims from the above-mentioned description and includes not only specific technical matters disclosed in the above-mentioned embodiments but also various modifications, alterations, alternative technologies and so forth that would be readily derived therefrom.

### INDUSTRIAL APPLICABILITY

According to the features of the present invention, when the first housing and the second housing are fitted to each other, the first ferrule is urged toward the fitting direction by the spring member, relative to the second ferrule that has been positioned by the fixing part. Therefore, the leading ends of the first ferrule and the second ferrule reliably come into contact with each other simply by providing the spring member in the first housing, without providing the spring member in the second housing. Owing to the above, it becomes possible to stabilize the connection of the optical fibers without inducing the troubles (for example, high-cost and weight increase) caused by the increase in the number of components.

### REFERENCE SIGNS LIST

1 optical connector apparatus
1A plug connector (first optical connector)
10 optical fiber assembly
11 plug-side optical fiber (first optical fiber)
12 plug-side ferrule (first ferrule)
20 plug-side housing (first housing)
21 plug-side main body (first main body member)
22 plug-side stopper (first stopper member)
23 spring member (elastic body)
1B in-line connector (second optical connector)
30 optical fiber assembly
31 in-line-side optical fiber (second optical fiber)
32 in-line-side ferrule (second ferrule)
40 in-line-side housing (second housing)
41 in-line-side main body (second main body member)
42 in-line-side stopper (second stopper member)
46 tapered part
47 positioning fixing part (fixing part)

1. An optical connector apparatus, comprising:
a first optical connector having a first housing that retains a first ferrule provided on a leading end of a first optical fiber; and
a second optical connector having a second housing that retains a second ferrule provided on a leading end of a second optical fiber,
leading ends of the first ferrule and the second ferrule coming into contact with each other by fitting of the first housing to the second housing, wherein
the first ferrule is urged toward a fitting direction of the first housing by an elastic body provided in the first housing, and
the second ferrule is positioned in a separating direction of the second housing by a fixing part provided in the second housing.

2. The optical connector apparatus according to claim 1, wherein
the second housing includes a second main body member and a second stopper member to be mounted to the second main body member, and
the second ferrule is guided to the fixing part by a tapered part provided in the second stopper member in a process of mounting the second stopper member to the second main body member.

3. The optical connector apparatus according to claim 1, wherein
the first housing includes a first main body member and a first stopper member to be mounted to the first main body member, and
the elastic body is formed by a leaf spring one end of which is fixed to the first stopper member and the other end of which urges the first ferrule toward the fitting direction of the first housing.

4. The optical connector apparatus according to claim 2, wherein
the first housing includes a first main body member and a first stopper member to be mounted to the first main body member, and
the elastic body is formed by a leaf spring one end of which is fixed to the first stopper member and the other end of which urges the first ferrule toward the fitting direction of the first housing.
